(19) United States
(12) Patent Application Publication
(10) Pub. No.: US 2010/0175628 A1
(43) Pub. Date: Jul. 15, 2010

(54) EXPERIMENTAL EQUIPMENT FOR LIVING ORGANISMS

(75) Inventor: Peter Allan SMITH, Eleebana (AU)

Correspondence Address: Nixon Peabody LLP, P.O. Box 60610, Palo Alto, CA, 94306, US

(73) Assignee: KINLEA HOLDING PTY LIMITED, Castle Hill NSW (AU)

(21) Appl. No.: 12/684,031

(22) Filed: Jan. 7, 2010

(30) Foreign Application Priority Data
Jan. 7, 2009 (AU) 2009900064

(51) Int. Cl. A01K 1/03

(52) U.S. Cl. 119/417; 119/472

(57) ABSTRACT

Apparatus for observing the behavior of ants and other similar organisms comprises housings having tubular connection ports for interconnection through flexible tubes and mounting legs for mounting the housings in an assembly in space with the housings spaced from one another.

### CROSS REFERENCE TO RELATED APPLICATIONS or PRIORITY CLAIM

This application claims priority of Australian Patent Application No. 2009900064, filed Jan. 7, 2009.

### FIELD OF THE INVENTION

The present invention relates to apparatus suitable for use for monitoring and conducting experiments and observations on living organisms such as ants or other beings of a similar character and especially those which exhibit colonization and social activities.

As an exercise in experimentation, education and enjoyment, equipment such as that known as ant farms has been made available to facilitate, through transparent portions of the equipment, observation to be made of the activities of living organisms such as ants. The use of such equipment can be of value in terms of education, and even be considered therapeutic.

However, equipment hitherto made available has limitations in form and performance and it is believed new and useful alternatives to known arrangements would be a useful development.

In one aspect, the present invention is directed to apparatus for use in observing behavior of living organisms and comprising a plurality of housings, each housing having connection ports adapted to engage with tubular connection means by which the housings may be selectively interconnected to provide passages through which the living organisms may move and/or develop, each of the housings further having mounting means each adapted to cooperate with a mounting leg, and the apparatus including mounting legs for mounting the housings whereby they are supported in space and in juxtaposition relative to one another.

Each of the mounting legs may be in the form of an elongate strut capable of absorbing tension and compression forces. Conveniently, each of the legs may have tips at respective ends profiled to engage in corresponding sockets in a housing.

In one embodiment the housings are substantially spherical and may be conveniently formed by interconnecting two substantially hemi-spherical portions. However, other shapes may be adopted.

In an embodiment each of the hemispherical portions may have a multiplicity e.g. three enter engagement sockets for receiving respective mounting legs and for this purpose it is highly advantageous for the sockets to be directed along respective paths parallel to one another and the end portion of each mounting leg may be cranked so that the axis of its engagement tip will result in the longitudinal axis of the strut extending at an acute angle from the axis of engagement of the tip with the socket in the housing. This arrangement facilitates efficient moulding and plastics material of the housing hemispheres, yet provides for secure and effective interconnection of respective housings.

The apparatus preferably also includes a multiplicity of tubular connectors such as flexible transparent tubes which interconnect respective ports on adjacent housings. Particularly where the apparatus is intended to observe the activity of ants, the tubes can be transparent and red in colour so that the ants perceive a dark environment which encourages their activity and movement.

Each of the housings preferably includes at least one observation window which may be disk shaped. The windows may have a selected optical design selected from wide angle viewing, magnifying viewing and plain viewing.

An optional feature for the apparatus is to include modules to be secured through appropriate ports to provide for feeding stations for water and food and the like.

Furthermore, the system may include appropriate, very small apertures for air exchange from the interior of the apparatus to the surrounding atmosphere.

In an important embodiment, the components are designed such that they may be interconnected into an extended array of housing modules normally intended to be supported on a base and for that purpose the base may comprise a multiplicity of inter-connectable modules with apertures for receiving and retaining tips of selected mounting legs. Another option is for mounting legs to include a suction foot to facilitate mounting (at least partially) the apparatus on a smooth surface such as a glass window.

For illustrative purposes only an example of the invention will now be described with reference to the accompanying drawings of which;

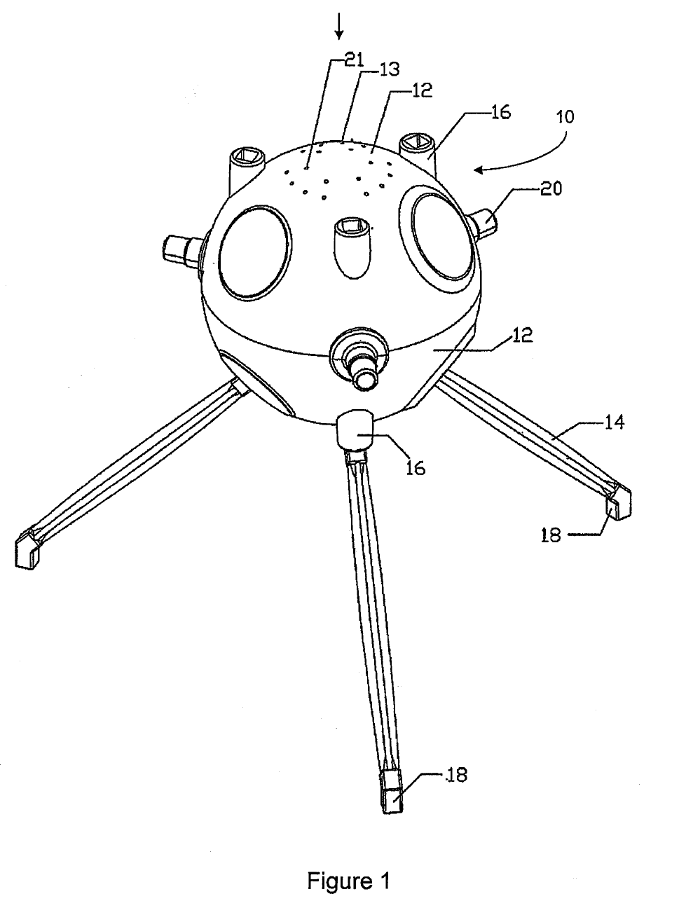

FIG. 1 shows a single housing with mounting legs and ready for connection to other elements of the apparatus;

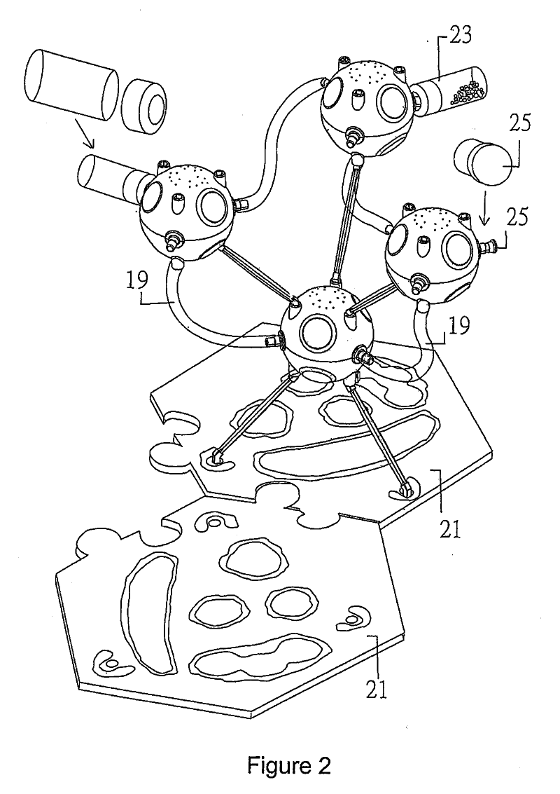

FIG. 2 shows the arrangement of FIG. 1 connected to other housings and interconnected with flexible tubes and mounted on base plates;

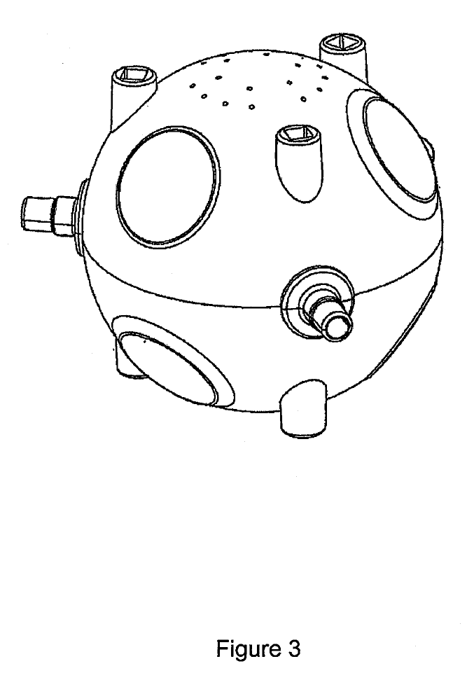

FIG. 3 is an isometric view of a single assembled housing comprising two mating hemispherical parts;

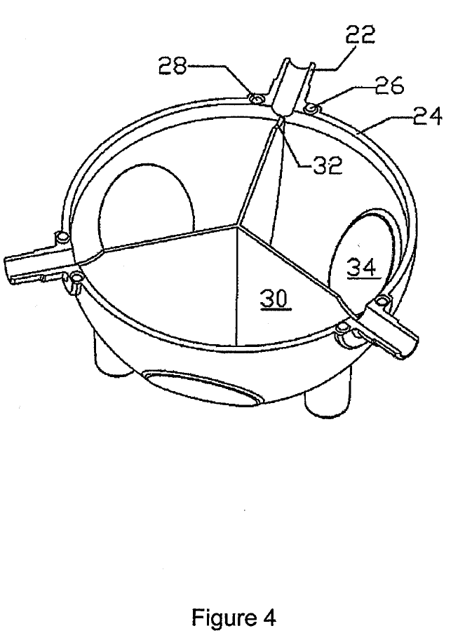

FIG. 4 is an interior view of the upper hemispherical housing portion of FIG. 3.

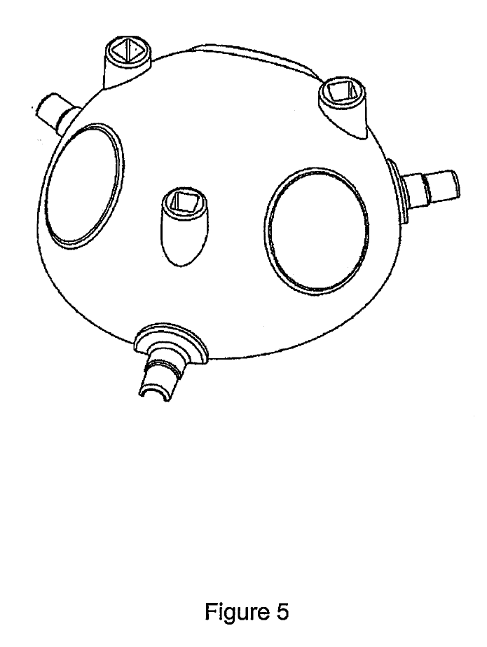

FIG. 5 is a bottom exterior view of the lower hemispherical housing of FIG. 3;

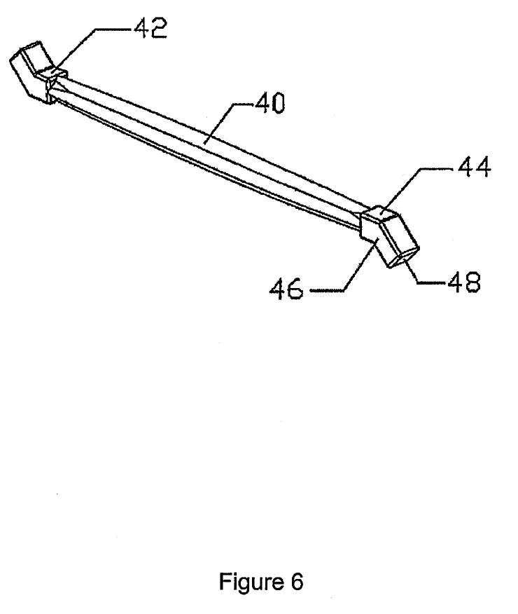

FIG. 6 is an isometric view of one of the mounting struts of the apparatus and

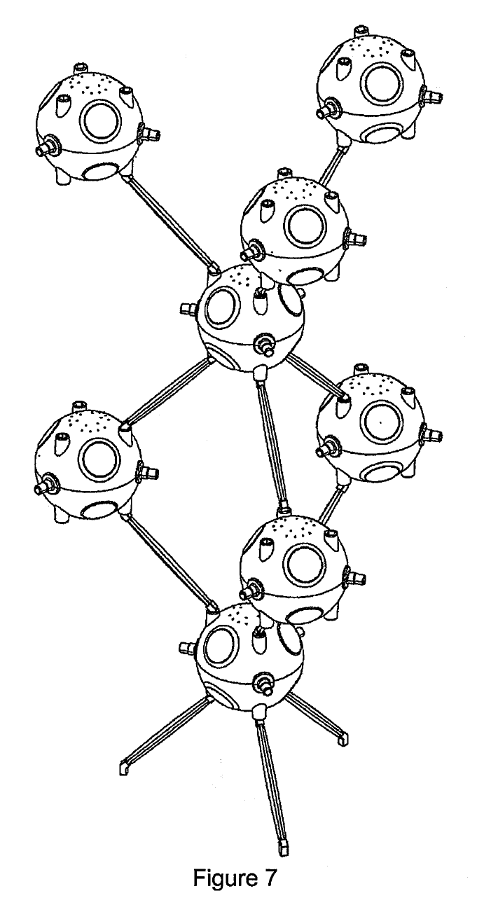

FIG. 7 illustrates a more extended array of components implementing an embodiment of the invention.

Typically the apparatus now described is supplied as a kit of parts which can either have a greater number of lesser number of components such as housings, mounting legs, connection tubes and optional peripheral units. Firstly the basic elements will be described.

A single housing connected to mounting legs is shown in FIG. 1 and adapted to be connected to other housings as will be described later.

FIG. 1 shows an assembled housing 10 formed from interconnected identical hemispherical bodies 12 and mounting legs 14, each housing body having a set of three axially directed sockets 16 adapted to receive by push fit tips 18 of the mounting struts. The housing 10 also has outwardly projecting tubular ports 20 defined between the interengaging housing bodies for connection to other housings through tubes through which ants can migrate and engage in their preferred activity.

FIG. 2 illustrates further housings interconnected to the first housing by additional mounting struts and shows also an example of interconnection tubes 19 and base plates 21 for supporting the assembled structure. Optional accessories namely ant feeding stations 23 and blanking closures 25 are shown.

If desired certain mounting struts could have a suction tip so that one or more of the housings could be supported on smooth panel such as glass.

FIG. 3 shows in more detail a typical assembled housing. In general the housings could be identical and formed of identical and aspherical portions but in the illustrated embodiment the general overall shape, configuration and the arrangement of the mating surfaces are identical in the two hemispheres but detailed differences are adopted. In this case, the upper hemisphere 13 has perforations 21 in its in crown and as best shown in FIG. 4 internally has three partition walls 30 having cutaway outer edges 32 for connection purposes. The lower hemisphere 15 in this embodiment can carry liquids and for that reason there is no perforations in the crown as shown in FIG. 5 and there are no internal walls to divide the interior into chambers.

As most clearly seen in FIG. 4, a series of three projections 22 are formed to extend away from the circular periphery 24. A location spigot 26 is defined to extend from the circular rim on one side of the port in an axial direction and on the other side a complementary recess 28 is provided. When assembly occurs, spigots 26 of the other housing engages in the recesses 28.

For structural integrity, the lower housing part incorporates three dividing walls 30 having a cutaway upper outer edge 32 to provide communication between separate chambers.

In this embodiment each chamber has a viewing window 34 and the windows can be selected to be optically different. For example, one window could be plain transparent plastic, another could have a magnifying effect and another may have a wide angle effect.

Each mounting strut is, as shown in FIG. 6 formed from an elongate spine 40 with integral end portions 42 having a square cross section base 44 extending axially and a square cross section tip 46 at an angle of around 40 degrees (but typically in the range 30 degrees to 60 degrees) terminating in a flat end face 48. The shoulders at the junction of each face of the tip are beveled and a slight taper is provided to facilitate push fitting of the cranked tip into the corresponding shape socket 16.

FIG. 7 shows how a large array may be formed within the scope of an embodiment of the invention, FIG. 7 omitting for clarity base elements and connecting tubes.

1. Apparatus for use in observing behavior of living organisms and comprising a plurality of housings, each housing having connection ports adapted to engage with tubular connection means by which the housings may be selectively interconnected to provide passages through which the living organisms may move and/or develop, each of the housings further having mounting means each adapted to cooperate with a mounting leg, and the apparatus including mounting legs for mounting the housings whereby they are supported in space and in juxtaposition relative to one another.

2. An apparatus in accordance with claim 1, wherein each mounting leg is in the form of an elongate strut capable of absorbing tension and compression forces.

3. An apparatus in accordance with claim 1 wherein each of the mounting legs has tips at respective ends profiled to engage in corresponding sockets in a housing.

4. An apparatus in accordance with claim 1, wherein the housings are substantially spherical.

5. An apparatus in accordance with claim 1 wherein each housing is formed by interconnecting two substantially hemi-spherical portions.

6. An apparatus in accordance with claim 1, wherein each housing is assembled from two hollow portions, each having a multiplicity of outwardly directed sockets for receiving corresponding tips at the end of the mounting legs.

7. An apparatus in accordance with claim 1, wherein each hollow portion is generally symmetrical about an axis and the sockets each extend substantially parallel to the axis.

8. An apparatus in accordance with claim 1, wherein each end portion of each mounting leg is cranked whereby, when installed, the mounting leg extends away from the socket at an acute angle e.g. 30° to 60°.

9. An apparatus in accordance with claim 1, and wherein the tubular connection means are included in the apparatus and are in for form of flexible transparent tubes adapted to interconnect with the ports on adjacent housings.

10. An apparatus in accordance with claim 1, wherein at least one of tubes are red in color

11. An apparatus in accordance with claim 1, wherein at least some of the housings include an observation window.

12. An apparatus in accordance with claim 1, wherein the windows are selected from optical designs for wide angle, magnified and plain viewing.

13. An apparatus in accordance with claim 1, and including base elements for interconnection with one another and for interengaging with mounting legs to support the apparatus when assembled.

14. Apparatus for use in observing behavior of living organisms and comprising a plurality of housings, each housing having connection ports adapted to engage with tubular connection means by which the housings may be selectively interconnected to provide passages through which the living organisms may move and/or develop, each of the housings further having mounting means each adapted to cooperate with a mounting leg, and the apparatus including mounting legs for mounting the housings whereby the housings are supported in space and in juxtaposition relative to one another, wherein each mounting leg is in the form of an elongate strut capable of absorbing tension and compression forces, each of the mounting legs having tips at respective ends profiled to engage in corresponding sockets in a housing, the housings are substantially spherical and each housing is assembled from two hollow portions, each having a multiplicity of outwardly directed sockets for receiving corresponding tips at the end of the mounting legs.

15. An apparatus in accordance with claim 14, wherein the tubular connection means are included in the apparatus and are in for form of flexible transparent tubes adapted to interconnect with the ports on adjacent housings.
